(19) United States
(12) Patent Application Publication
(10) Pub. No.: US 2010/0287766 A1
(43) Pub. Date: Nov. 18, 2010

(54) METHOD AND APPARATUS FOR FASTENING A DECORATIVE ITEM TO CLOTHING

(76) Inventor: John Peterson, Brick, NJ (US)

Correspondence Address: Mr. Walter J. Tencza Jr., Suite 210, 100 Menlo Park, Edison, NJ, 08837, US

(21) Appl. No.: 12/467,333

(22) Filed: May 18, 2009

(51) Int. Cl. B23P 19/00

(52) U.S. Cl. 29/798

(57) ABSTRACT

An apparatus for attaching a decorative item, such as a flower, to clothing. The apparatus may include a first section having a first slot, a second section having a second slot, and a connecting section which connects the first section and the second section. The apparatus may also include a first attachment device, such as a first pin, connected to the first section, wherein the first attachment device is closer to the first section than the second section, and a second attachment device, such as a second pin, connected to the second section, wherein the second attachment device is closer to the second section than the first section.

### FIELD OF THE INVENTION

This invention relates to improved methods and apparatus concerning holding or fastening a decorative item, such as a flower, to clothing.

### BACKGROUND OF THE INVENTION

There are various devices known in the prior art for fastening decorative items, such as flowers, to clothing. For example, it is known to use a single pin to fasten or pin a flower or corsage to clothing.

### SUMMARY OF THE INVENTION

In one embodiment of the present invention an apparatus is provided for attaching a decorative item to clothing. The apparatus may include a first section having a first slot, a second section having a second slot, and a connecting section which connects the first section and the second section. The apparatus may also include a first attachment device connected to the first section, wherein the first attachment device is closer to the first section than the second section, and a second attachment device connected to the second section, wherein the second attachment device is closer to the second section than the first section.

The connecting section may connect the connect the first section and the second section so that the first section is parallel to the second section and the first slot overlays the second slot. The first and second attachment devices may include first and second pins, respectively, each having a point or sharpened edge. The first pin and the second pin may be fixed to the first section and the second section, respectively, so that the first pin and the second pin are substantially parallel with respect to each other. The first pin and the second pin may be substantially parallel to the connecting section.

The first section and the second section may be separated by a first distance and the first pin and the second pin may be separated by approximately the first distance. Each of the first slot and the second slot may gradually increase in size from a narrow opening to a base. Each of the first section and the second section may include first and second extensions which are flexible. The connecting section may be elongated and may be substantially longer than any dimension of the first and second sections.

In at least one embodiment, the apparatus may include or may have inserted therein a decorative item having a stem which has been inserted into the first slot and the second slot.

In another embodiment of the present invention a method is provided including inserting a decorative item into first and second slots of an apparatus, and attaching the apparatus to clothing.

### BRIEF DESCRIPTION OF THE DRAWINGS

FIG. 1A shows a top perspective view of a first portion of an apparatus in accordance with an embodiment of the present invention;

FIG. 1B shows a bottom perspective view of the first portion of FIG. 1A;

FIG. 2 shows a top perspective view of the first portion of FIG. 1A attached to second and third portions, to form an assembled apparatus of an embodiment of the present invention;

FIG. 3 shows a top perspective view of a flower inserted into the first portion of FIG. 1A; and

FIG. 4 shows a top perspective view of the flower inserted into the first portion, and the first portion attached to a lapel of a suit.

### DETAILED DESCRIPTION OF THE DRAWINGS

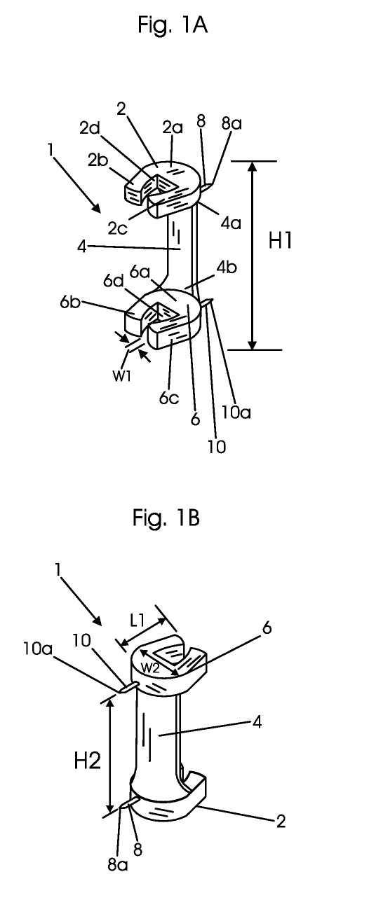

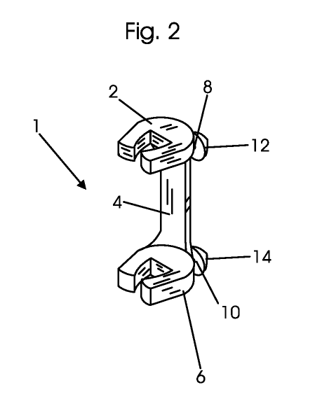

FIG. 1A shows a top perspective view of a first portion 1 of an apparatus in accordance with an embodiment of the present invention. FIG. 1B shows a bottom perspective view of the first portion 1 of FIG. 1A. FIG. 2 shows a top perspective view of the first portion 1 of FIG. 1A attached to a second portion, cap, clasp 8 and a third portion, cap or clasp 10, to form an assembled apparatus of an embodiment of the present invention.

The first portion 1, as shown in FIGS. 1A and 1B, includes a top or first section, 2, a middle or connecting section 4, and a bottom or second section 6. The middle or connecting section 4 connects the top section 2 to the bottom section 6. The first portion 1 includes pins 8 and 10 which are fixed to the back of the top section 2 and the bottom section 6, respectively. The pins 8 and 10 include pointed or sharpened ends 8a and 10a, respectively. The pins 8 and 10 are fixed so that they are substantially perpendicular to the middle section 4. The pins 8 and 10 are substantially rigid with respect to the middle section 4 so that they remain substantially perpendicular and are not easily bent.

Each of the top section 2 and the bottom section 6 may have a semi-circular, horseshoe, or substantially semicircular or substantially horseshoe shape. Each of the top section 2 and bottom section 6 may have a length L1 of a half of an inch and a width W2 of a half of an inch, shown for bottom section 6 in FIG. 1B. The top section 2 includes a base 2a, and extensions 2b and 2c. The base 2a, and extensions 2b and 2c partially surround a gap or slot 2d. Similarly, the bottom section 6 includes a base 6a, and extensions 6b and 6c. The base 6a, and extensions 6b and 6c partially surround a gap or slot 6d. The top section 2 and the bottom section 6 may be identical or substantially identical. There may be a distance or separation of W1 between ends of the extensions 2b and 2c and between ends of the extensions 6b and 6c. The distance or separation W1 may be an eighth of an inch.

The distance or separation W1 allows the stem of a flower, such as stem 104 of the flower 100, or another decorative object, to be inserted through narrow openings 2e and 6e and into the slots or openings 2d and 6d. Alternatively, if a bottom 104a of the stem 104 is smaller than the slots or openings 2d and 6d, then the bottom 104a of the stem 104 can be first inserted into the larger slot 2d opening through the top of top section 2, and then passed through the larger slot 6d opening through the top of bottom section 6 to place the flower into portion 1.

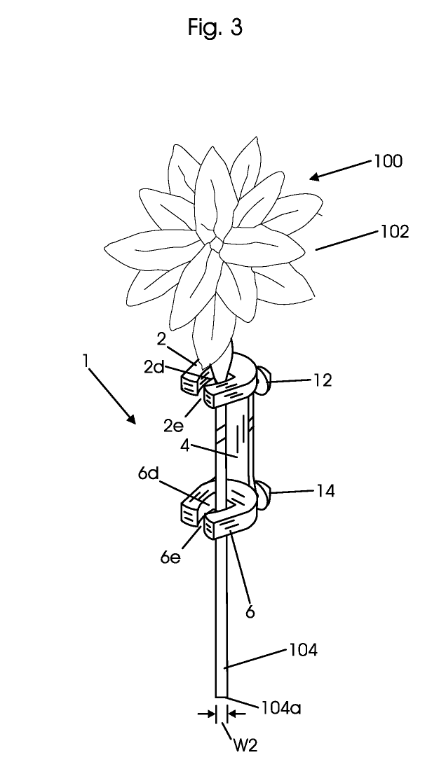

The slot or openings 2d and 6d may gradually increase from a size of a one eighth of an inch at narrow openings 2e and 6e, respectively, to a size of a quarter or a half of an inch near the base 2a and 6a, respectively. The extensions 2b-c and 6b-c may be flexible with respect to the bases 2a and 6a, respectively, so that if a diameter or width W2, shown in FIG. 3, of the stem 104 is larger than the narrow openings 2e and 2f, the extensions 2b-c and 6b-c can flex outwards to temporarily enlarge narrow openings 2e and 6e and allow the stem 104 to be inserted into slots 2d and 6d. This is helpful for when the bottom of a decorative object, such as the bottom 104a, is larger than the openings or slots 2d and 6d, so that the bottom 104a cannot be inserted into and through slots 2d or 6d.

The middle section 4 may be rigid or substantially rigid. The top section 2 may be rigidly attached to the middle section 4 at end 4a and the bottom section 6 may be rigidly attached to the middle section at opposing end 4b.

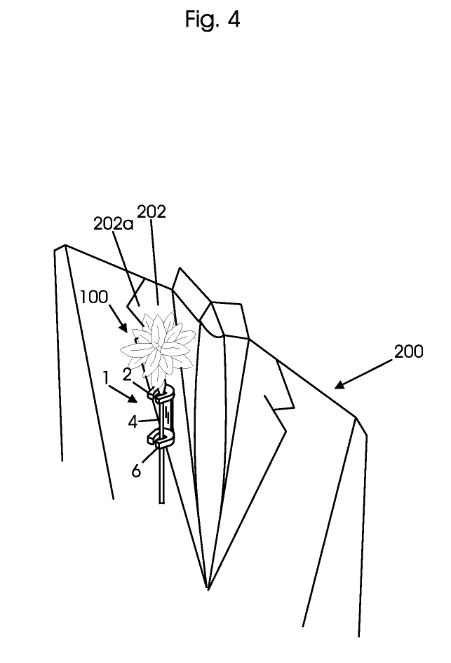

The portion 1 may have a height H1, shown in FIG. 1A, which may be about one and one half inches, from a top surface of the top section 2 to a bottom surface of the bottom section 6. The distance H2, shown in FIG. 1B, between the points or sharp edges 8a and 10a of the pins 8 and 10, respectively, may be about one inch. The points 8a and 10a are spread out so that when a flower, such as flower 100 in inserted into the portion 1, and attached to clothing, such as suit 200 as in FIG. 4, the portion 1 remains stable on the clothing and has less of a tendency to tear or rip the clothing. The top section 2, the bottom section 6, and the middle section 4 may be made of a rigid plastic or some other rigid material. The slots 2d and 6d may range from one quarter of an inch for W1, at the ends of the extensions (2b and 2c, or 6b and 6c), to a spacing of three eighths of an inch near the bases 2a and 6b, respectively.

The connecting or middle section 4 may be about one inch in length along the dimension of H2 in FIG. 1B and may have a width of approximately W2 shown in FIG. 1B. The connecting section 4 may be elongated and may be substantially longer, in one embodiment twice as long as any dimension of the top section 2 or bottom section 6.

The caps 12 and 14, shown in FIG. 2, are used to cover the sharp ends 8a and 10a of the pins 8 and 10, respectively, and to help hold the portion 1 to clothing. The pins 8 and 10 may be made of metal.

FIG. 3 shows a top perspective view of a flower 100 inserted into the first portion 1 of FIG. 1A. FIG. 4 shows a top perspective view of the flower 100 inserted into the first portion 1, and the first portion 1 attached to a lapel 202 of a suit 200.

As shown in FIG. 3, the flower 100 includes leaf or bulb portion 102 and stem 104. The stem 104 is inserted into the slots 2d and 6d. The slots 2d and 6d should be large enough to allow the insertion of the stem 104 of certain types of flowers, but small enough so that leaf or bulb portion 102 is larger than the openings or space in the slots 2d and 6d and so that leaf or bulb portion 102 does not slip through the slots 2d and 6d. The caps 12 and 14 are shown attached in FIG. 3, however, typically the pins 8 and 10 would first be inserted through clothing, such as through the lapel 202 of the suit 200 in FIG. 4, and then the caps 12 and 14 would be attached behind the clothing. In FIG. 4, the top, middle, and bottom sections 2, 4, and 6, respectively, of the portion 1, rest on a top surface 202a of the lapel 202 of the suit 200, while the caps 12 and 14, are attached to pins 8 and 10 so that the caps 12 and 14, not shown in FIG. 4, rest on a rear surface, opposite surface 202a. Cloth of the lapel 202 lies between the sections 2, 4, and 6, and the caps 12 and 14.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for attaching a decorative item to clothing comprising:
a first section having a first slot;
a second section having a second slot;
a connecting section which connects the first section and the second section;
a first attachment device connected to the first section, wherein the first attachment device is closer to the first section than the second section; and
a second attachment device connected to the second section, wherein the second attachment device is closer to the second section than the first section.

2. The apparatus of claim 1 wherein
the connecting section connects the first section and the second section so that the first section is parallel to the second section and the first slot overlays the second slot.

3. The apparatus of claim 1 wherein
the first attachment device includes a first pin having a point; and
the second attachment device includes a second pin having a point.

4. The apparatus of claim 3 wherein
the first pin and the second pin are fixed to the first section and the second section, respectively, so that the first pin and the second pin are substantially parallel with respect to each other.

5. The apparatus of claim 4 wherein
the first pin and the second pin are substantially parallel to the connecting section.

6. The apparatus of claim 3 wherein
the first section and the second section are separated by a first distance and the first pin and the second pin are separated by approximately the first distance.

7. The apparatus of claim 1 wherein
each of the first slot and the second slot gradually increase in size from a narrow opening to a base.

8. The apparatus of claim 1 wherein
each of the first section and the second section includes first and second extensions which are flexible.

9. The apparatus of claim 1 wherein
the connecting section is elongated and is substantially longer than any dimension of the first and second sections.

10. The apparatus of claim 1 and further comprising
a decorative item having a stem which has been inserted into the first slot and the second slot.

11. A method comprising
inserting a decorative item into first and second slots of an apparatus; and
attaching the apparatus to clothing;
wherein the apparatus includes
a first section having the first slot;
a second section having the second slot;
a connecting section which connects the first section and the second section;
a first attachment device connected to the first section, wherein the first attachment device is closer
a second attachment device connected to the second section, wherein the second attachment device is closer to the second section than the first section.

12. The method of claim 11 wherein
the connecting section connects the first section and the second section so that the first section is parallel to the second section and the first slot overlays the second slot.

13. The method of claim 11 wherein
the first attachment device includes a first pin having a point; and
the second attachment device includes a second pin having a point.

14. The method of claim 13 wherein
the first pin and the second pin are fixed to the first section and the second section, respectively, so that the first pin and the second pin are substantially parallel with respect to each other.

15. The method of claim 14 wherein
the first pin and the second pin are substantially parallel to the connecting section.

16. The method of claim 13 wherein
the first section and the second section are separated by a first distance and the first pin and the second pin are separated by approximately the first distance.

17. The method of claim 11 wherein
each of the first slot and the second slot gradually increase in size from a narrow opening to a base.

18. The method of claim 11 wherein
each of the first section and the second section includes first and second extensions which are flexible.

19. The method of claim 11 wherein
the connecting section is elongated and is substantially longer than any dimension of the first and second sections.

20. The method of claim 11 and further comprising
a decorative item having a stem which has been inserted into the first slot and the second slot.
